(19) United States
(12) Patent Application Publication
(10) Pub. No.: US 2015/0340948 A1
(43) Pub. Date: Nov. 26, 2015

(54) SWITCHING MODE POWER SUPPLY

(71) Applicant: WB ELECTRONICS S.A., OZAROW MAZOWIECKI (PL)

(72) Inventor: PIOTR POSTAWKA, MYSLOWICE (PL)

(21) Appl. No.: 14/712,983

(22) Filed: May 15, 2015

(30) Foreign Application Priority Data
May 22, 2014 (PL) P.408286

(51) Int. Cl. H02M 3/156; H02M 1/36

(52) U.S. Cl. CPC H02M 3/156; H02M 1/36

(57) ABSTRACT

Switching mode power supply, includes a main converter, an output capacitor (Cw), a control system and an auxiliary power supply of low power, in which an output (Wyzp) of the auxiliary power supply of low power is connected to the output capacitor (Cw), measuring input (Fb) of an output voltage (Uout) stabilization of the main converter and a connector (K1) with an output (Wypg) of the main converter, and connector contacts (K2) with a pulse load. Outputs (Wysk1) and (Wysk2) of the control system are connected to respective control inputs (Wesk1) and (Wesk2) controlling the work of connectors (Kw1) and (Kw2). The control output (W1) is connected to a start input (Wespg) of the main converter.

### CROSS-REFERENCE TO RELATED APPLICATION

This application claims priority of Polish Application No. P.408286, filed on May 22, 2014, and which is incorporated herein by reference.

### TECHNICAL FIELD

The present invention relates to a switching mode power supply, in particular for powering of transmitting-receiving apparatuses, used to power electronic devices, mostly mobile transceivers.

### BACKGROUND ART

A switching mode power supply, particularly for powering of transmitters, built from a mains rectifier, a pulse width control system, a gating system comprising a high voltage switching transistor, an output transformer and rectifier with a filter is known from the Polish Patent PL141776. Mains voltage rectifier powers the gating system with an output transformer and the pulse width control system. To the output connected is a rectifier with a filter, to which the load is plugged. The power supply also includes an output voltage stabilizing system for the load, with a galvanic isolation from the mains power supply of the gating system and pulse width control system. For galvanic isolation of the load from the mains power supply is used an optocoupler. Alternating voltage of 220 V/50 Hz after conversion and filtering feeds the gating system, which converts the DC voltage obtained from the rectifier to a rectangular wave voltage and a frequency of a magnitude of several to several tens of kHz. The rectangular voltage, after transformation by the transformer powers the rectifier with a filter, at the output of which is obtained direct current voltage, which powers the load.

A disadvantage of the known power supply is the use of coupling via an optocoupler causing that the change of the output voltage given at the input of the pulse width control system is not transmitted directly, but is burdened with an error resulting from the response characteristics of the optocoupler, as well as errors due to thermal changes and scattering of parameters of all elements of the feedback loop.

Another disadvantage of the known power supply is the stabilization of only one chosen output voltage and the others are stabilized in a limited range.

An energy efficient system of a switching mode power supply with power Po, consisting of two power supply modules: main one with a power of Po1 and an auxiliary one with a power Po2, is known from the U.S. Pat. No. 7,173,833. The outputs of the two power supply modules are connected directly to the output capacitor Co. During low power intake works only the auxiliary power supply module, while when the load increases the main power supply module is turned on. Time sequences of the main and auxiliary power supply are controlled by the integrated in them active elements controlled by signals delivered from the control system coupled by means of optical connectors with the output capacitor Co.

A disadvantage of the known energy efficient switching power supply is that during the start of work both power supply modules work simultaneously, which results in the emission of a significant level of radio distortions preventing the work of the receiver systems. Another disadvantage of this power supply is that for its proper work it is required that the converter used in it had a so called soft start system. As a result, the response time of the main DC/DC power supply module to pulse load change is too slow, and in the case of an abrupt increase in load, e.g. during start of transmission over the power amplifier WCZ, on the output of the power supply appears a rapid decrease in the voltage, which prevents stable operation of the transmitter.

Known switching mode power supplies are not suitable for powering of transmitting-receiving systems (transceivers), in particular those in which the final stages of radio transmitters operate in TDMA (Time Division Multiple Access) based multiple access.

Due to the pulsed nature of the power consumption of this type of load, it is necessary to use power supplies with low internal impedance, operating in a wide frequency range. Basic methods of reducing the output impedance of the switching mode power supply is the use of feedback and moving of the formed pole by smoothing the voltage ripples of converter output capacity in the direction of lower frequencies.

In the case of the low frequency area, in which for the output impedance of the converter responsible is mainly the feedback loop, the main limitation is the maximum gating frequency of the converter, which has a direct impact on the possible speed of the impulse response of the converter, and thus its output impedance. In the case of current components of higher frequencies (above the pole formed by the load replacement resistance and filtering output capacitances) for the output impedance of the converter responsible mainly is the series impedance (ESR) of the output filter elements.

For the most demanding loads such as linear high frequency amplifiers operating in the pulse mode, it becomes necessary to use relatively large output capacities, with high frequency gating of power converters giving effective low output impedances of such systems in a wide range of frequencies.

Because the current consumption of the power amplifiers usually lasts for a very small percentage of the total working time of the system, in practice it appears that the greatest contribution to the overall efficiency of the system comes from idle power consumption of the converter working in the state of no-load output. The current consumption consists of switching losses of gating elements, eddy current losses in the core inductance, power consumption by the control system of the converter, etc. In addition, a very serious problem is electromagnetic radiation emitted by the converter in the idle phase operation.

If you turn off a typical converter for the duration of a typical absence of power consumption by the load, the situation becomes even more complicated, because the self-discharge of the output capacitors takes place, and after restarting, the converter control system needs to complete the charge on the output capacitors (raise the output voltage), which is always connected with output voltage instability of the converter, and in cases of significant output capacitor discharge a time-consuming procedure of converter soft-start takes place (in order to limit the maximum current of gating systems). Such a situation often occurs in the radio apparatus when going from reception to transmitting, when the output stages of transmitters remained off for a long time.

Another disadvantage of switching mode power supply is the high level of emitted radio-electrical interference and significant power consumption during idle mode operation.

The problem of energy consumption by power supplies operating in idle mode is solved by many methods. A common method is to use additional, operating in parallel, power supplies with low-power supporting the control functions of powered circuits. This is a method commonly used in consumer electronics. This method provides the ability to sustain the work of critical parts of the system such as clocks, remote control receivers etc. However, it does not provide a possibility for immediate start of equipment powered by the main power supply. Start-up time of the main converter is usually just a few to a couple hundred milliseconds. This time is due to the need to supplement the charge on the output capacitors of the main converter and limit the maximum current of control stage. Another approach to solving this problem is to change the operating mode of the main converter. These advanced methods are based on a change in the feedback loop action of the main converter depending on the load of the converter. Feedback loop parameters change in such a way as to switch from continuous control of the output voltage of the main converter main, which is achieved by means of fluid control of pulse width modulation (PWM) factor of a converter operating in CCM mode (continuous-conduction-mode), into a discontinuous adjustment mode e.g. with the so-called cycle stealing being a DCM mode (Discontinuous-conduction-mode) or work with a fixed frequency (e.g. pulse frequency modulation PFM). In this mode, we agree to a higher output voltage pulsations of the main converter due to the recharge of output capacity with pulse pulses or, occurring less frequently, pulses with a larger (usually the maximum allowed) energy. This mode increases the output voltage ripples, but significantly reduces the power consumption of the control circuit of the converter due to the reduction in the amount of charge reloads of gates of gating transistors. This is because each charge reload of gates of control transistors requires the delivery of a minimum “package” of energy. An example of an advanced solution applying the above technology (Light-Load PFM) are converter controllers employed by Texas Instruments TPS family systems (e.g. TPS82692, etc.) or solutions used by the Fairchild company in systems such as, for example, FAN5354. A slightly different approach was applied in their solutions by the ON Semiconductor company, using the so-called APC (Adaptive Power Control) mode. The developed at ON Semiconductor technology enables, like the previous solutions, work in CCM for large loads and smooth transition to the DCM mode for small loads. The essence of this idea is the absence of the need for a step change in the control loop mode of operation and a smooth transition from one mode to another.

In some applications, these methods are not very beneficial, given the continuous generation of EM interference, also during operation without load (in Light-Load DCM mode). In case of some of the presented methods, the spectrum spreading techniques are used additionally in order to improve the performance of EM interference emission. However, while the technology based on spectrum spreading are effective in the case of measurements made in accordance with the applicable standards of electromagnetic compatibility, it turns out that they do not eliminate the production of broadband high frequency noise by the steep slopes of the output pulses of such converters. This phenomenon is a major obstacle in the construction of power supplies for broadband transceiver systems with low input noise.

Due to the fact that in transmitting-receiving apparatuses we can accurately predict the moments in which a sudden power uptake from the converter will take place, the switching mode power supply design of the present invention has been specifically optimized to work in such conditions, and its construction allows to avoid the problems associated with transient states occurring during the switching on and off of the pulse converter, as well as allows to avoid the need of its constant work in the absence of power consumption by the load, while providing the ability to immediately run the converter in the event of the need to provide more power to the load.

### SUMMARY OF THE INVENTION

The aim of the invention is to provide a system of a switching mode power supply without the above disadvantages and inconveniences, especially shortening the reaction time of the switching mode power supply to a pulse load growth and lowering of levels of radio noise emissions.

This aim is achieved according to the invention by providing a switching mode power supply consisting of a main converter, an output capacitor Cw, a control system and an auxiliary power supply of low power.

The power supply is characterized in that an output of the auxiliary power supply of low power is connected to the output capacitor, measuring input of the main converter output voltage stabilization, and a connector to an output of the main converter, and with the connector contacts with a pulse load and an output of the control circuit are connected to respective inputs controlling the operation connectors, while the control output is connected to a start input of the main converter.

In one embodiment the main converter has a hard start system which allows it to immediately start working at full load without a phase of forced gradual increase in pulse width.

According to the invention it is particularly advantageous if the auxiliary power supply of low power has an output current limit.

In another embodiment the auxiliary power supply of low power output voltage is not less than the rated output voltage.

In still another embodiment the output voltage of the loaded main converter main is not lower than the rated output voltage.

In yet another embodiment of the power supply, wherein during the start-up the switches have open contacts and the voltage (Ucw) at the output capacitor (Cw) increases to achieve voltage (Uzn) using the energy supplied by the auxiliary power supply of low power (3).

In a further embodiment, connectors are executed using the active components working in the main converter and the pulse load.

In yet a further embodiment, a control output of the control circuit is connected to a control input of the auxiliary power supply of low power.

In another embodiment, the control system has the main converter activation input connected to an external request signal for supplying of power to the load.

The system according to the invention is free from defects and drawbacks of known switching mode power supplies, and what is more, allows shortening the response time of switching mode power supply to a pulse load growth and reduces the level of emission of radio interference.

### BRIEF DESCRIPTION OF THE DRAWINGS

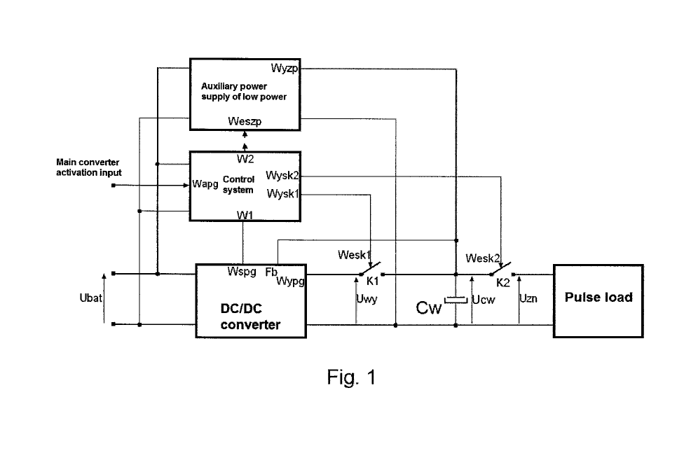

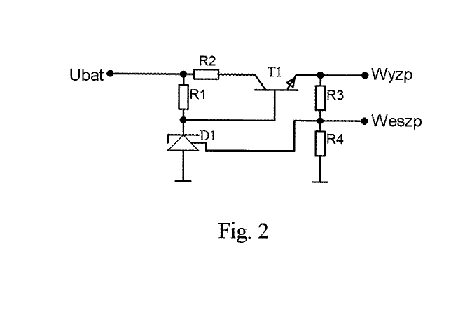

The object of the invention is illustrated in the embodiment in the drawing, in which FIG. 1 shows a power supply in a block model, and FIG. 2 is a functional diagram of the auxiliary power supply.

### BEST MODE FOR CARRYING OUT THE INVENTION

In the exemplary embodiment shown in FIG. 1, the switching mode power supply, consisting of a main converter 1, an output capacitor Cw, a control circuit 2, and an auxiliary power supply of low power 3, has the output Wyzp from an auxiliary power supply of low power 3 connected to the output capacitor Cw, measuring input Fb of the stabilization system of output voltage Uout of the main converter 1 and the connector K1 with an output Wypg of the main converter 1 and with connector contacts K2 with a pulse load 6. Outputs Wysk1 and Wysk2 of the control circuit 2 are connected to corresponding inputs Wesk1 and Wesk2 controlling the operation of connectors Kw1 and Kw2. W1 control output is connected to a starting input Wespg of the converter 1.

After the supply of powering Ubat voltage to the input of the switching mode power supply the main converter 1, control system 2 and the auxiliary power supply of low power 3 are powered. The contacts of the connectors K1 and K2 are open and the auxiliary power supply of low power 3 charges the output capacitor Cw up to a voltage of Uzn. In the inactive phase of operation, namely when the load 6 is not connected, the connector K2 remains open, the auxiliary power supply of low power 3 maintains the nominal output voltage on the capacitor Cw, and the main converter 1 is turned off. At the moment of transition to pulse increased load 6, namely after receiving an external activation signal for the main inverter, an activation input Wapg of the control circuit 2 is given a trigger signal turning on the main converter 1, the control unit 2 starts the main converter 1, and simultaneously closes the connectors K1 and K2. After closing the connectors K1 and K2, the Fb input of the feedback system of the main converter 1, compares the voltage of the output capacitor Cw with a predetermined reference voltage, and the feedback system stabilizes the output voltage level Uzn of the power supply. If during low power consumption by the load 6 (in the inactive operation phase of the system) a voltage Ucw on the output capacitor Cw, is kept close enough to the nominal value of the output voltage Uzn of the main converter 1, then the transition to work after a steep increase of the load 6 (active phase) may take place in a small number of cycles of the main converter and without saturating the regulating loop of this converter, which dramatically improves the time response of the converter occurring at the time of its start of operation. The possible adjustment of the voltage associated with the voltage difference maintained across the output capacitor Cw by the auxiliary power supply 3, and the nominal voltage resulting from the operation of the regulating loop of the main converter 1, is so small that there is no saturation of any part of the regulating loop of the main converter 1, eliminating completely the need for the so-called soft start of the main converter 1. The adjustment of this voltage is associated with delivering or receiving a portion of the electric charge to/from the output capacitor Cw, so it cannot, due to the limited maximum output/input current of the main converter 1, take place immediately. It is possible to set the auxiliary power supply 3 voltage Ucw so that it is not lower than the nominal output voltage Uwy of the main converter 1, and after the transition to the active phase (where high power is transmitted to the load 6) the load, for a short period of time, uses the load accumulated in the output capacitor Cw, which causes a voltage drop across the capacitor, and the main converter 1 itself, through a mild increase in controlling pulses width modulation factor starts operation gradually from the minimal output currents until it reaches the nominal output current parameters. Since the auxiliary power supply 3 is equipped with an output current limiting system, there is no risk of its damage in the active phase, because after a small reduction of the voltage across the output capacitor Cw the output current of this power supply is limited to a predetermined, maximum safe value.

In another, not shown in the drawing, embodiment of the power supply according to the invention, the control system controls the operation of the main converter 1 and the auxiliary power supply of low power 3. In this embodiment, for improving the energy efficiency of the entire system, after transit to the active phase the control system 2, for the duration of the transmission of power to the load 6, turns off the auxiliary power supply of low power 3. The control system 2, just before transition of the main converter 1 to the inactive state turns this power supply on again. Since in the inactive phase the main converter 1 stays off, it does not uptake energy at that time and does not generate electromagnetic interference.

FIG. 2 shows a diagram of one possible, very simple implementation of the auxiliary power supply 3, wherein the limiting of the output current is achieved by means of a resistor R2, and the setting of the output voltage Ucw is executed by a divider constructed from resistors R3, R4. The voltage Ubat which is powering the auxiliary power supply 3 must be sufficiently higher than the nominal voltage Ucw maintained on the output capacitor Cw. In cases where a high efficiency of the system is required, or when the main converter 1 is a voltage boost converter, the voltage Ubat powering the auxiliary power supply 3 can be produced from the main powering voltage Uwy by a low-power converter which lowers or increases the voltage accordingly.

### LIST OF REFERENCES

1—Main converter,
2—Controlling system,
3—Auxiliary power supply of low power,
4—K1 connector,
5—K2 connector,
6—Pulse load,
7—Cw output capacitor,
8—Ucw voltage across the capacitor,
9—Uw output voltage,
10—Uzn rated voltage,
11—Ubat powering voltage,
12—W1 control output of control system,
13—Wesk1 control input of connector operation,
14—Wesk2 control input of connector operation,
15—Wspg control input,
16—Fb measurement input,
17—Wyzp output of auxiliary power supply of low power,
18—Wypg main converter output,
19—Wysk1 control system output,
20—Wysk2 control system output,
21—W2 control output of control system,
22—Wapg main converter activation input.

1. Switching mode power supply, comprising a main converter, an output capacitor (Cw), a control system and an auxiliary power supply of low power, wherein an output (Wyzp) of the auxiliary power supply of low power is connected to the output capacitor (Cw), measuring input (Fb) of an output voltage (Uout) stabilization of the main converter and a connector (K1) with an output (Wypg) of the main converter, and connector contacts (K2) with a pulse load, whereas outputs (Wysk1) and (Wysk2) of the control system are connected to respective control inputs (Wesk1) and (Wesk2) controlling the work of connectors (Kw1) and (Kw2), and the control output (W1) is connected to a start input (Wespg) of the main converter.

2. The power supply according to claim 1, wherein the main converter has a hard start system allowing it to immediately start working with a full load.

3. The power supply according to claim 1, wherein the auxiliary power supply of low power has a limiting of output current.

4. The power supply according to claim 1, wherein an output voltage (Ucw) of the auxiliary power supply of low power is not lower than an output voltage (Uzn).

5. The power supply according to claim 1, wherein an output voltage (Uwy) of the loaded main converter is not lower than the output voltage (Uzn).

6. The power supply according to claim 1, wherein during the start-up the connectors (K1) and (K2) have their contacts open, and the voltage (Ucw) across the output capacitor (Cw) increases to achieve the voltage (Uzn) using the energy supplied by the auxiliary power supply of low power.

7. The power supply according to claim 1, wherein the connectors K1 and K2 are made using the active components working in the main converter, and the pulse load.

8. The power supply according to claim 1, wherein a control output (W2) of the control system is connected to a control input (Weszp) of the auxiliary power supply of low power.

9. The power supply according to claim 1, wherein the control system has an activation input (Wapg) of the main converter.
